(19) United States
(12) Patent Application Publication
(10) Pub. No.: US 2026/0099744 A1
(43) Pub. Date: Apr. 9, 2026

(54) COMPLEX DATA ENCODING FOR QUANTUM CIRCUITS

(71) Applicant: Dell Products L.P., Round Rock, TX (US)

(72) Inventors: Brendan Burns Healy, Haddonfield, NJ (US); Yasmin Mansy, Cairo (EG)

(21) Appl. No.: 18/906,506

(22) Filed: Oct. 4, 2024

(51) Int. Cl. G06N 10/20

(52) U.S. Cl. CPC G06N 10/20

(57) ABSTRACT

Encoding data for a quantum circuit is disclosed. Data may be chunked and tokenized. The tokenized data is encoded to generate an encoding suitable for input to a quantum circuit. Coefficients of the encoding are represented as complex numbers. This allows multiple values, such as the original data and their relative positions to be encoded in the same encoding. Thus, the output of the encoding engine is an encoding that contains or represents various aspects of the original input.

### TECHNOLOGICAL FIELD OF THE DISCLOSURE

Embodiments disclosed herein generally relate to quantum computing systems, quantum circuits, and/or encodings for quantum computing systems and quantum circuits. More particularly, at least some embodiments relate to systems, hardware, software, computer-readable media, and methods for encoding data as input to quantum circuits.

### BACKGROUND

Quantum processing units (QPUs) are, simply stated, the engine or processor of a quantum computing system. While a bit is a basic unit of data or information in classic computing, a qubit is the equivalent unit in quantum computing. In contrast to conventional bits, a qubit is not limited to being 0 or 1. A qubit can exist in a superposition of both states simultaneously. In addition, qubits in a quantum computing system can be entangled, which essentially means that the state of one qubit may depend on the state of another qubit. This is one of the reasons that quantum computing systems are potentially more powerful than classical computing.

Quantum computing systems can be used for a wide range of applications, including machine learning and natural language processing. One of the challenges in using quantum computing systems with natural language processing relates to encoding the data input to the quantum computing system. More specifically, it is not enough to simply tokenize and encode a query as input to the quantum computing system. The reason is that the order of the text or tokens in the query are important, particularly in natural language processing. As a result, it is also necessary to encode the relative positions of tokens associated with the query. The need to encode positional data, however, substantially increases the number of qubits required for an operation as well as computing overhead.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of encoding data for a quantum computing system;

FIG. 1B discloses additional aspects generating an encoding for a quantum computing system;

FIG. 2 discloses additional aspects of encoding data for a quantum computing system that includes multiple aspects of a query;

FIG. 3 discloses aspects of encoding input as tokens or as input to a quantum computing system;

FIG. 4 discloses additional aspects of encoding chunks and positional information together in the same token;

FIG. 5 discloses aspects of encoding tokens with reference to a unity circle;

FIG. 6 discloses aspects of a method for encoding input suitable for a quantum computing system or quantum circuit; and

FIG. 7 discloses aspects of a computing device, system, and/or entity.

### DETAILED DESCRIPTION OF SOME EXAMPLE EMBODIMENTS

Embodiments disclosed herein generally relate to quantum computing systems and encoding data for quantum computing systems. More particularly, at least some embodiments relate to systems, hardware, software, computer-readable media, and methods for encoding data for quantum circuits in quantum computing systems.

Example embodiments of the invention are discussed in the context of quantum computing systems. Examples of quantum computing systems may include, but are not limited to, real or physical quantum computing systems, emulated quantum computing systems, and the like. Embodiments of the invention may be implemented with real quantum hardware or with emulated quantum hardware in classical computing systems with memory, processors, and other classical hardware.

Quantum computing may be integrated into various applications or operations including training machine learning models, executing machine learning models, natural language processing, large language models (LLMs) of various kinds (e.g., question/answer, chatbots, search, and the like).

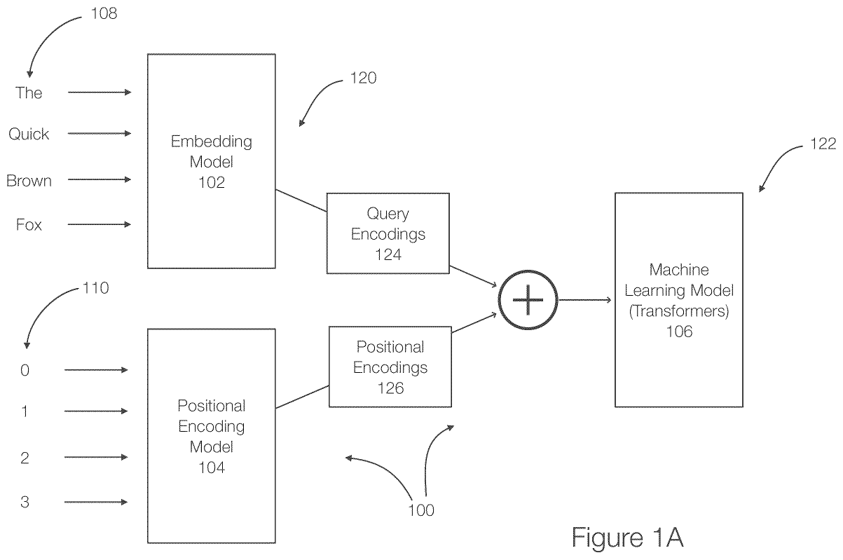

FIG. 1A illustrates an example of encoding data in the context of applications that include or rely on a large language model (LLM) or in the context of training a machine learning model that may include or use an LLM. In the system 100, an operation is performed in stages. Aspects of the application may performed in a stage 120 and/or in a stage 122. Aspects of the stages 120 and 122 may be performed using quantum computing, classical computing, or combinations thereof. Further, the system 100 may operate as a pipeline or in an iterative manner.

In the stage 120, a quantum computing system may be configured as or used in conjunction with an embedding model 102. In this example, an input 108 of “The Quick Brown Fox” is encoded or embedded by the embedding model 102. The output of the embedding model 102 may include a vector representation (an output vector) of the input 108 and is illustrated as query encodings 124. More specifically, the input 108 may be chunked. The chunks are tokenized and then encoded for input a quantum circuit The output may be a prompt that can be input to another model, such as an LLM. The output vector may also be used, by way of example only, to generate a dataset for an adversarial model in the context of a generative adversarial network, as an input to an operation for pruning an existing model, or the like.

Because the system 100 is operating in the context of natural language processing in this example, it is beneficial to encode a positional input 110. More specifically, the order of the text or words in the input 108 matter and the relative positions of the words matters. The positional input 110 represents the order or positions (or relative positions) of words/tokens in the input 108. As illustrated in FIG. 1A, the input 108 (e.g., a query) is encoded separately from the positional input 110. The positional encoding model 104, which is or includes a quantum computing system, outputs a vector representation such as positional encodings 126. The outputs of the embedding model 102 and the positional encoding model 104 are combined and input to a machine learning model 106 in the stage 122.

In one example, the machine learning model 106 may be a transformer (a type of neural network architecture). The model 106 may not process the query encodings 124 sequentially. Thus, the positional encodings 126 are also generated and used by the model 106 to ensure that the operation accounts for the positions or order of the tokens in the input 108. The model 106 may generate an output that may be returned to a user in one example or used as input to a subsequent stage.

FIG. 1B discloses additional aspects of encoding data for a quantum computing system in an improved manner. The system 150 may receive the same input 108 as the system 100. In this example, the embedding model 152 accounts for positional data when encoding an input 108, such as a query. Thus, the output of the embedding model 102 is query encodings with positional data 154. The model 106 may operate on the encoding 124 generated by the embedding model 152.

The encoding 154, in one example, is a vector representation of tokens that includes positional data. The overhead associated with FIG. 1A is reduced in the system 150 if not eliminated because the relative positions of the tokens is encoded by the embedding model 152 in the same encoding as the tokens representing the input 108. This results in a significant data overhead savings in the QPU that receives the encoding 154 as input.

Quantum computing systems can be configured to perform compute-intensive workloads, such as training machine learning models or LLMs. This particular use-case involves loading significant amounts of data into memory for training the model. However, aspects of training machine learning models may also include the use of classical computing systems. More specifically, the workflow for many applications or processes, such as training a machine learning model, often includes both quantum computing and classical computing.

In one example, the inclusion of quantum computing systems into a multiple-node workflow may follow a schema such as Variational Quantum Algorithm (VQA) schema. A VQA schema allows the quantum computing system to iteratively process data interspersed with classical nodes, which gives the advantage that the quantum computing system does not need to stay in coherence indefinitely.

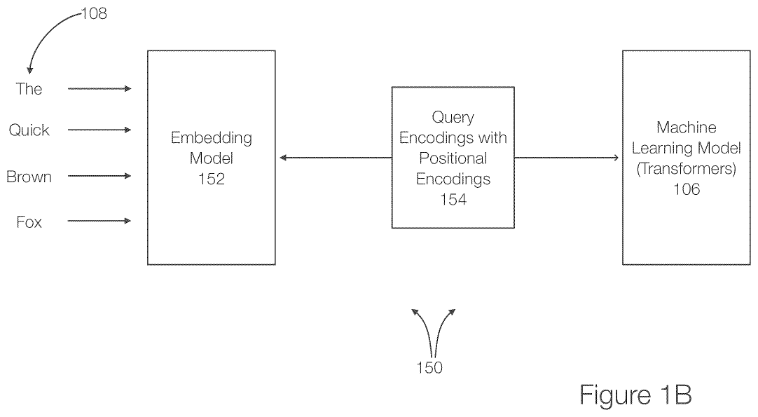

FIG. 2 discloses aspects of a variational quantum algorithm and aspects of encoding data for a quantum computing system. In this example embodiment, the encoding engine 212 is configured to generate, as output, an encoding that is configured to be input to a quantum computing system. The encoding engine 212 may include or use a quantum computing system and/or a classical computing system.

In one example, the encoding engine 212 is configured to generate an encoding that includes both the query and positional data in the same encoding. This advantageously reduces compute overhead, reduces the number of qubits required for execution, and conserves computing time.

In one example, the encoding engine 212 may generate or be used to generate an encoding 214 that may be used as input to a quantum computer 204 or used to prepare the input state 202 of the quantum computer 204 (or the quantum circuit). The encoding 214 may represent an initial state for the qubits of the quantum computer 204 being used for the encoding operation.

More specifically, a QPU (or quantum circuit included in the QPU) includes qubits. The input state 202 (or encoding 214) identifies the initial values of the qubits being used. The quantum computer 204 executes the quantum circuit using the encoding 214. At some point, a measurement is performed. Measuring the output or result of a quantum circuit collapses the quantum states of the qubits into classical states. Thus, the measurement state 201 typically includes 1s and 0s. Classical computing 208 may be performed using the measurement state 206, by way of example to optimize parameters 210 or perform other functions using the output or measurement state 206 of the quantum computer 204. The parameters 210 are typically configured to parameterize the quantum circuit of the quantum computer 204. In one example, the parameters 210 may relate to rotation angles for quantum gates. This process may be repeated until convergence is achieved. In one example, the operations illustrated in FIG. 2 are aspects of training a machine learning model.

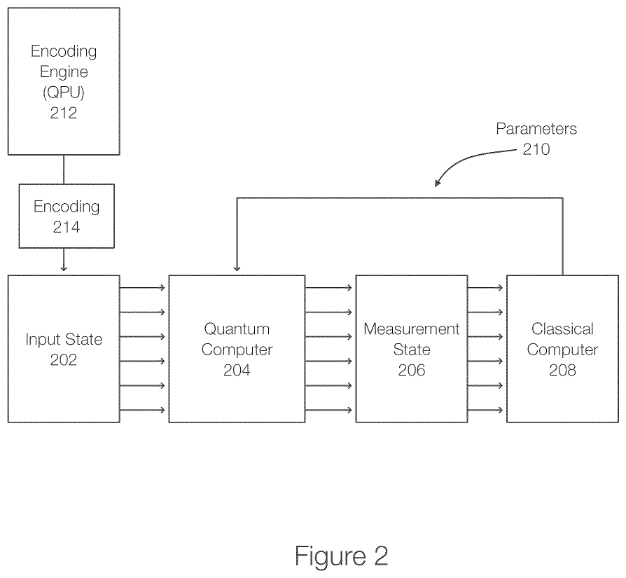

FIGS. 3-5 illustrate an example of encoding data such that the encoded data includes positional information with respect to a specific number of tokens. However, embodiments of the invention may apply equally to an encoding with n tokens.

FIG. 3 discloses aspects of loading data into a quantum processing unit and more specifically illustrates an encoding that may serve as input to a quantum circuit or used to prepare the input to a quantum circuit. FIG. 3 is presented by way of example only and provides an example with 5 tokens. Embodiments of the invention, however, can be generalized to n tokens. FIG. 3 illustrates an example of encoding 302 that represents the text “horse”. The encoding 302 may be input into a quantum computing system or, more specifically, into a quantum circuit.

In this example, each letter of the text 306 (or query) is tokenized and each token encoded with an initial state for corresponding qubits. The encoding 302 thus represent the initial states of qubits used for each of the tokens. However, in the encoding 302, the positional relationship of the tokens (e.g., the letters) of the text “horse” is not present and is not retained in the encoding 302.

The coefficients illustrated in the encoding 302 do not represent the weight of each letter because the coefficients as illustrated do not sum to 1 in this example. In one example, a magnitude of the coefficients may be viewed as a complex number. For a purely real number (a+0*i), the magnitude is a². The magnitude corresponds to the weight. In this example of FIG. 3, each letter has the same weight, and the weights sum to 1.

Embodiments of the invention represent the coefficients of an encoding using complex numbers or values. For example, the coefficient 304 may be represented as

$$( 0 + i \frac{1}{\sqrt{5}} ) .$$

The magnitude is a real number in this example when the coefficient 304 is represented as a complex number.

Representing the coefficients as a complex number allows the weights of the tokens to be retained and allows positional information to be conveyed or included in the same encoding as the information representing the text 306.

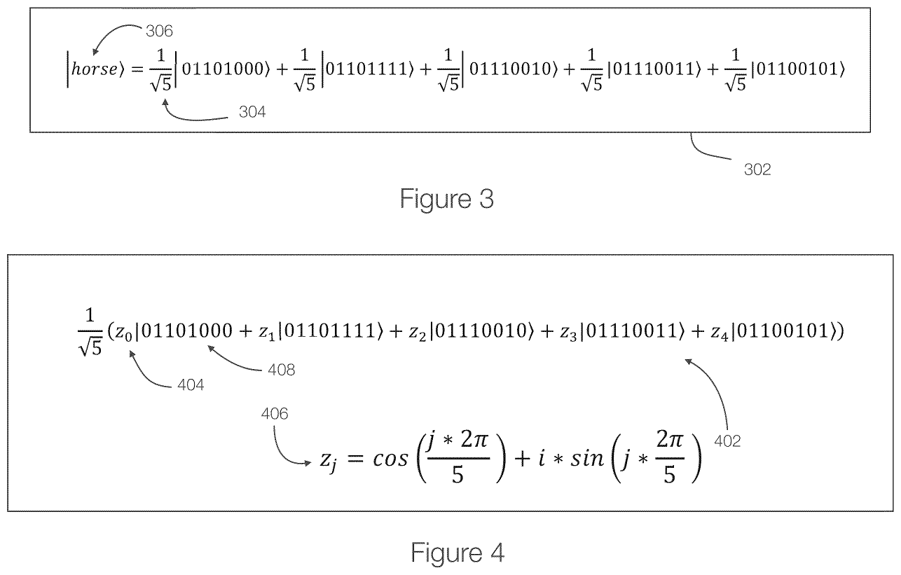

FIG. 4 discloses aspects of encoding tokens and positional information together in the same encoding. In FIG. 4, each coefficient for the tokens in the encoding 402 is represented as a complex number. However, the coefficient of the first term in the encoding 402 includes positional information represented as a complex number but is purely real. More specifically, in the case of the first coefficient z₀, the coefficient is purely real. The coefficient 404 in the encoding 402, using the equation 406, for the first token (for j=0,) is:

$${z}_{0} = \frac{1}{\sqrt{5}} ( cos ( \frac{0 * 2 π}{5} ) + i * sin ( \frac{0 * 2 π}{5} ) )$$

$$or$$

$${z}_{0} = \frac{cos ( 0 )}{\sqrt{5}} = \frac{1}{\sqrt{5}} .$$

Similarly, the encoding for the second token (for j=1) is

$${z}_{1} = \frac{1}{\sqrt{5}} ( cos ( \frac{1 * 2 π}{5} ) + i * sin ( \frac{1 * 2 π}{5} ) )$$

$$or$$

$${z}_{1} = \frac{cos ( \frac{2 π}{5} ) + i * sin ( \frac{1 * 2 π}{5} )}{\sqrt{5}} .$$

The other coefficients in the encoding 402 are similarly determined based on the value of j:0, 1, 2, 3, or 4 in this example. As previously stated, the coefficients are complex numbers, although the first coefficient may be purely real in one example.

The encoding 402 preserves the weights of the various tokens while distinguishing the tokens using complex values. This difference allows each of the coefficients to represent positional data for each of the tokens in addition to the text or tokens of the query.

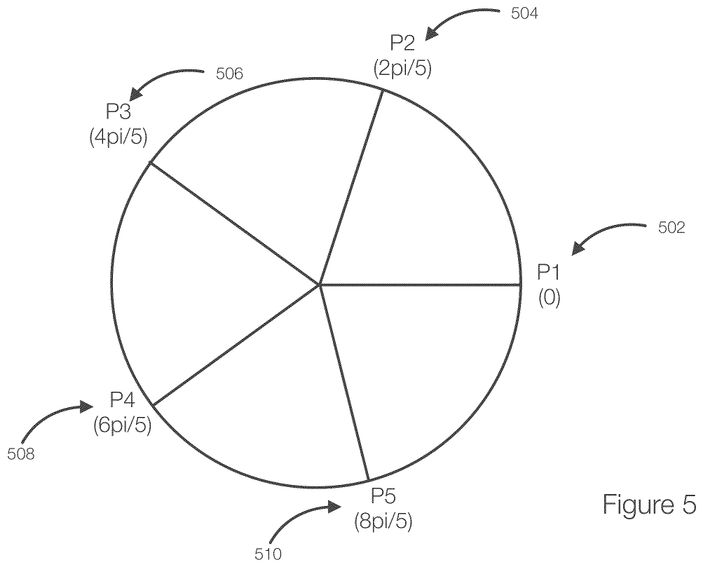

FIG. 5 illustrates aspects of generating an encoding for a quantum circuit based on fifth roots of unity. In this example and with reference to FIG. 4, each of the coefficients z₀ . . . z₄ is associated with a different angle or phase. For the fifth roots of unity, the angles or phases are:

$$0 , \frac{2 π}{5} , \frac{4 π}{5} , \frac{6 π}{5} , and \frac{8 π}{5} .$$

These values or phases correspond, respectively, to: P1 502, P2, 504, P3 506, P4 508, and P5 510 in FIG. 5. In this example, the order of the tokens corresponds to with a counter-clockwise representation around the unity circle. Thus, P1 502 identifies the position of the first token relative to the other tokens. P2 504 represents the relative position of the second token relative to the other tokens. The other tokens are similarly represented in a counter-clockwise manner. This is an example of how the position of each token may be determined or inferred using complex values. It is possible to use other representations.

Embodiments of the invention provide each coefficient with a shifted phase or encode tokens with different phases or in a complex form in a manner that conveys positional information for each of the tokens in a string of tokens. In one example, the initial or first token may be a purely real token. Subsequent tokens may be spaced evenly along the complex circle. As previously indicated, embodiments of the invention can adapt to n tokens. In the example of FIG. 5, n=5.

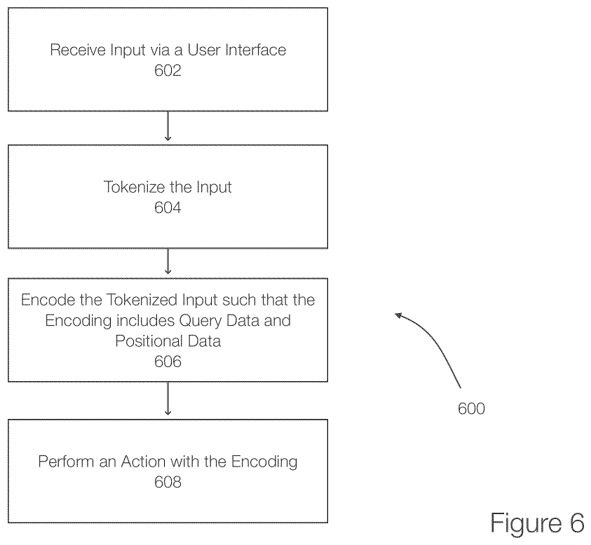

FIG. 6 discloses aspects of a method for encoding input suitable for a quantum computing system or a quantum circuit. The method 600 includes aspects of encoding data for input to a quantum circuit or quantum computing system. Embodiments of the invention, however, may be involved in a wide variety of applications including applications that include or use an LLM.

The method 600 is further described in the context of incorporating two values or two inputs into a single encoding. The values or characteristics of the input being incorporated into the encoding may be related or may not be related. In one example, the method 600 encodes tokens generated from a query (or other text) with positional data of the text or tokens. Thus, these two characteristics or aspects of the original input are related in this example. The positional data describes the order of the tokens generated from the query or provides relative positions of the tokens.

Embodiments of the invention more generally relate to encoding multiple values, inputs or the like into a single encoding. Thus, some elements of the method 600 may be replaced with other elements, characteristics, or aspects, or the like, that are germane to other applications or operations.

In this example, input (e.g., a query) is received 602 via a user interface or other manner. The input may be from a previous stage of a pipeline, from a user, or the like. The input is tokenized 604. Tokenizing the input may include chunking the input into smaller parts. In the context of natural language processing, a query may be chunked or split, by way of example, into words or phrases. The example of FIG. 4 effectively chunked the input into letters. Once the chunks are obtained or generated, the chunks are converted into tokens.

Once the tokens are generated, the tokenized input is encoded 606 to generate an encoding for a quantum circuit. The encoding includes or represents the tokens (e.g., the text or chunks) and their relative positions within the query or input (positional information). Each encoded token may include a coefficient and binary data (e.g., initial qubit values). The positional data is represented using complex numbers for the coefficients. This can be achieved without altering the weights represented by the coefficients. By way of example, encoding the tokens may include preparing the tokens by mapping each of the qubits represented in the token to a quantum state. With reference to the encoding 402, each token is associated with 8 qubits, whose initial values are indicated at 408 for the first token in this example.

Embodiments of the invention advantageously reduce the number of qubits required for a quantum job, reduce computing overhead, and reduce execution time.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, encoding operations, machine learning training operations, quantum computing system operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving tokenized input into an encoding engine, and encoding the tokenized input into an encoding that is configured to be input to a quantum circuit of a quantum computing system, wherein each token of the encoding includes a coefficient represented as a complex number, wherein the complex number includes positional information of the tokens in the tokenized input.

Embodiment 2. The method of embodiment 1, wherein a first coefficient of the encoding is purely real.

Embodiment 3. The method of embodiment 1 and/or 2, wherein an input comprises text and the tokenized input comprises chunks generated by chunking the text.

Embodiment 4. The method of embodiment 1, 2, and/or 3, wherein an output of the quantum computing system comprises a prompt for training a large language model or comprises a prompt as input to a large language model.

Embodiment 5. The method of embodiment 1, 2, 3, and/or 4, wherein weights associated with each of the tokens is unchanged by representing the coefficients as complex numbers.

Embodiment 6. The method of embodiment 1, 2, 3, 4, and/or 5, wherein the encoding comprises n tokens that are spaced equally when represented in a unity circle.

Embodiment 7. The method of embodiment 1, 2, 3, 4, 5, and/or 6, wherein each of the coefficients has an equal weight.

Embodiment 8. The method of embodiment 1, 2, 3, 4, 5, 6, and/or 7, further comprising replacing coefficients in the tokenized input with complex values in the encoding.

Embodiment 9. The method of embodiment 1, 2, 3, 4, 5, 6, 7, and/or 8, wherein the encoding represents multiple values associated with the input such that multiple values are represented in the encoding, the values including aspects of the chunks and their relative positions.

Embodiment 10. The method of embodiment 1, 2, 3, 4, 5, 6, 7, 8, and/or 9, wherein encoding the coefficients as complex numbers provides a different phase to each of the coefficients, wherein the positional information of the tokens in the encoding is represented by the different phases of the coefficients.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

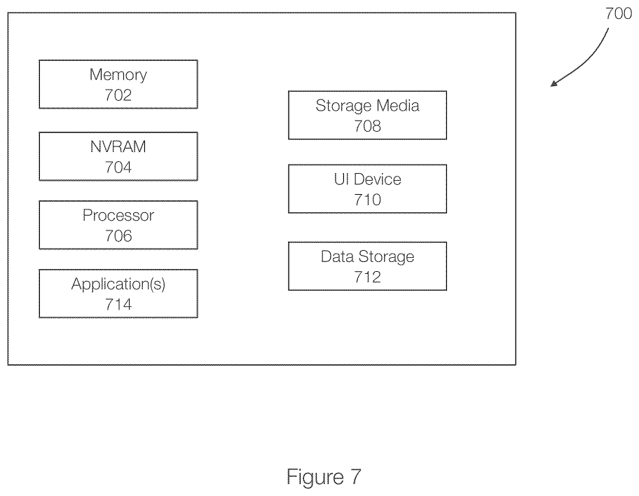

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

The device 700 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 700 may also represent a physical or virtual machine or server, an edge-based computing system, a cloud-based computing system, server clusters or other computing systems or environments. The device 700 may also represent multiple machines or devices, whether virtual, containerized, or physical. The device 700 may perform or execute steps or acts of the methods illustrated in the Figures.

The device 700 may represent a cloud-based system, an edge-based, system, an on-premise system, or combinations thereof. Document understanding and related operations may be performed using these types of computing environments/systems.

The described embodiments are to be considered in all respects only as illustrative and not restrictive. All changes which come within the meaning and range of equivalency of the claims are to be embraced within their scope.

What is claimed is:

1. A method comprising:
receiving tokenized input into an encoding engine; and
encoding the tokenized input into an encoding that is configured to be input to a quantum circuit of a quantum computing system, wherein each token of the encoding includes a coefficient represented as a complex number, wherein the complex number includes positional information of the tokens in the tokenized input.

2. The method of claim 1, wherein a first coefficient of the encoding is purely real.

3. The method of claim 1, wherein an input comprises text and the tokenized input comprises chunks generated by chunking the text.

4. The method of claim 1, wherein an output of the quantum computing system comprises a prompt for training a large language model or comprises a prompt as input to a large language model.

5. The method of claim 1, wherein weights associated with each of the tokens is unchanged by representing the coefficients as complex numbers.

6. The method of claim 1, wherein the encoding comprises n tokens that are spaced equally when represented in a unity circle.

7. The method of claim 6, wherein each of the coefficients has an equal weight.

8. The method of claim 1, further comprising replacing coefficients in the tokenized input with complex values in the encoding.

9. The method of claim 1, wherein the encoding represents multiple values associated with the input such that multiple values are represented in the encoding, the values including aspects of the chunks and their relative positions.

10. The method of claim 1, wherein encoding the coefficients as complex numbers provides a different phase to each of the coefficients, wherein the positional information of the tokens in the encoding is represented by the different phases of the coefficients.

11. A non-transitory storage medium having stored therein instructions that are executable by one or more hardware processors to perform operations comprising:
receiving tokenized input into an encoding engine; and
encoding the tokenized input into an encoding that is configured to be input to a quantum circuit of a quantum computing system, wherein each token of the encoding includes a coefficient represented as a complex number, wherein the complex number includes positional information of the tokens in the tokenized input.

12. The non-transitory storage medium of claim 11, wherein a first coefficient of the encoding is purely real.

13. The non-transitory storage medium of claim 11, wherein an input comprises text and the tokenized input comprises chunks generated by chunking the text.

14. The non-transitory storage medium of claim 11, wherein an output of the quantum computing system comprises a prompt for training a large language model or comprises a prompt as input to a large language model.

15. The non-transitory storage medium of claim 11, wherein weights associated with each of the tokens is unchanged by representing the coefficients as complex numbers.

16. The non-transitory storage medium of claim 11, wherein the encoding comprises n tokens that are spaced equally when represented in a unity circle.

17. The non-transitory storage medium of claim 16, wherein each of the coefficients has an equal weight.

18. The non-transitory storage medium of claim 11, further comprising replacing coefficients in the tokenized input with complex values in the encoding.

19. The non-transitory storage medium of claim 11, wherein the encoding represents multiple values associated with the input such that multiple values are represented in the encoding, the values including aspects of the chunks and their relative positions.

20. The non-transitory storage medium of claim 11, wherein encoding the coefficients as complex numbers provides a different phase to each of the coefficients, wherein the positional information of the tokens in the encoding is represented by the different phases of the coefficients.
